(19) United States
(12) Patent Application Publication
(10) Pub. No.: US 2006/0225769 A1
(43) Pub. Date: Oct. 12, 2006

(54) Isothermal control of a process chamber

(76) Inventors: Gentaro Goshi, Chikushino-shi (JP); William Jones, Phoenix, AZ (US)

Correspondence Address: HAVERSTOCK & OWENS LLP, 162 NORTH WOLFE ROAD, SUNNYVALE, CA, 94086, US

(21) Appl. No.: 11/094,876

(22) Filed: Mar. 30, 2005

(51) Int. Cl. B08B 3/02

(52) U.S. Cl. 134/10; 134/18; 134/25.4; 134/26; 134/56 R; 134/111; 134/113; 134/108; 134/105; 134/94.1; 134/95.1

(57) ABSTRACT

An apparatus for use in providing a fluid at a predetermined temperature is disclosed. The apparatus comprises: means for supplying a first quantity of a fluid at a first temperature; means for supplying a second quantity of a fluid at a second temperature; and flow-control means for controlling a ratio of the first quantity of the fluid to the second quantity of the fluid for forming a mixed fluid, wherein the ratio is determined in response to a measured temperature of the mixed fluid.

### FIELD OF THE INVENTION

The invention in general relates to the field of semiconductor wafer processing. More particularly, the invention relates to an apparatus and method of isothermal control of a process chamber.

### BACKGROUND OF THE INVENTION

It is well known that particulate surface contamination of semiconductor wafers typically degrades device performance and affects yield in the industry. When processing wafers, it is desirable that particles and contaminants such as photoresist, photoresist residue, and residual etching reactants and byproducts be minimized.

Fluids have been employed in the processing of semiconductor wafers. For example, supercritical and near-supercritical carbon dioxide have been used as solvents to clean contaminants from the surfaces of semiconductor device structures. A fluid enters the supercritical state when it is subjected to a combination of pressure and temperature at which the density of the fluid approaches that of a liquid. Supercritical fluids exhibit properties of both a liquid and a gas. For example, supercritical fluids are characterized by high solvating and solubilizing properties that are typically associated with the liquid state and Supercritical fluids also have low viscosities that are characteristic of compositions in the gaseous state.

A problem in semiconductor device manufacturing is that during the processing of wafers with a supercritical fluid, when pressure and/or temperature changes of the fluid occur, any solids such as hydrocarbons contained in the fluid have a tendency to fall out and condense on the wafer. It would be advantageous to eliminate or minimize the occurrence of particles that fall out onto the wafer surface during processing with a fluid.

It is known that temperature control during the processing of semiconductor wafers is related to quality control. One problem is that the heat in a process chamber can be lost, for example, to the chamber walls or during the step of opening the chamber to facilitate the movement of wafers in and out of the chamber. It would be advantageous to control the temperature of a fluid during the processing of semiconductor wafers, for example, to achieve higher chip value, improved throughput, and increased manufacturing yield.

What is needed is an apparatus for providing a fluid at a controlled temperature and pressure or a controlled range of temperatures and pressures.

### SUMMARY OF THE INVENTION

One embodiment of the invention includes a processing system that includes a processing chamber having a processing chamber inlet and a processing chamber outlet; a recirculation subassembly having an inlet coupled to the processing chamber outlet and an outlet coupled to the processing chamber inlet, where the recirculation subassembly comprises a pump assembly and a bypass assembly coupled to the pump assembly, the bypass assembly comprising a first branch and a second branch; and a controller coupled to the bypass assembly for switching the bypass assembly between a first mode and a second mode, wherein when the bypass circuit is in a first mode, a first path is establish through the recirculation subassembly that includes the pump assembly and the first branch, and when the bypass circuit is in a second mode, a second path is establish through the recirculation subassembly that includes the pump assembly and the second branch.

### BRIEF DESCRIPTION OF THE DRAWINGS

A more complete appreciation of various embodiments of the invention and many of the attendant advantages thereof will become readily apparent with reference to the following detailed description, particularly when considered in conjunction with the accompanying drawings, in which:

FIG. 1 shows an exemplary block diagram of a processing system in accordance with an embodiment of the invention;

FIG. 2 illustrates a simplified block diagram of a fluid supply subassembly in accordance with an embodiment of the invention;

FIG. 3 illustrates an exemplary graph of pressure versus time for a supercritical process in accordance with an embodiment of the invention;

FIG. 4 illustrates a flow diagram of a method of operating a fluid supply subassembly in accordance with an embodiment of the invention; and

FIG. 5 illustrates a simplified block diagram of a heating device for use in a fluid supply subassembly in accordance with an embodiment of the invention.

### DETAILED DESCRIPTION OF SEVERAL EMBODIMENTS

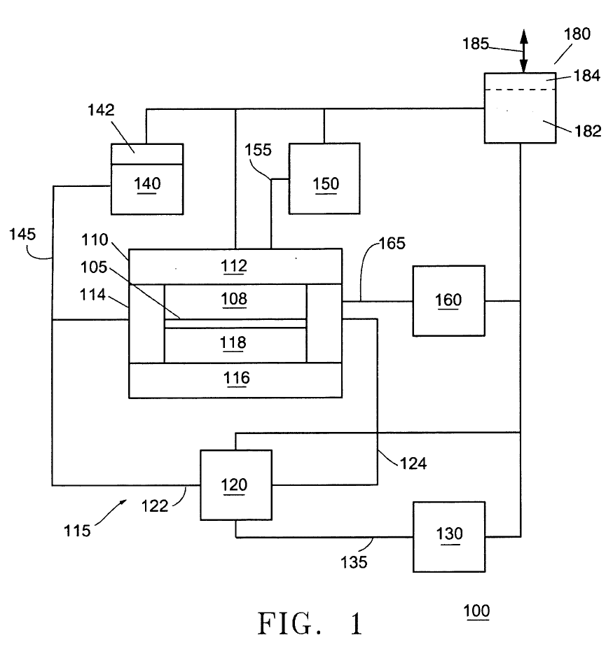

FIG. 1 shows an exemplary block diagram of a processing system 100 in accordance with an embodiment of the invention. In the illustrated embodiment, processing system 100 comprises a process module 110, a recirculation system 120, a process chemistry supply system 130, a high-pressure fluid supply system 140, a pressure control system 150, an exhaust system 160, and a controller 180. In one embodiment, high-pressure fluid supply system 140 comprises a fluid supply subassembly 142. Alternately, a fluid supply subassembly 142 can be arranged and/or configured differently. The processing system 100 can operate at pressures that can range from 1000 psi. to 10,000 psi. In addition, the processing system 100 can operate at temperatures that can range from 40 to 300 degrees Celsius.

The details concerning one example of a processing chamber are disclosed in co-owned and co-pending U.S. patent applications, Ser. No. 09/912,844, entitled “HIGH PRESSURE PROCESSING CHAMBER FOR SEMICONDUCTOR SUBSTRATE,” filed Jul. 24, 2001, Ser. No. 09/970,309, entitled “HIGH PRESSURE PROCESSING CHAMBER FOR MULTIPLE SEMICONDUCTOR SUBSTRATES,” filed Oct. 3, 2001, Ser. No. 10/121,791, entitled “HIGH PRESSURE PROCESSING CHAMBER FOR SEMICONDUCTOR SUBSTRATE INCLUDING FLOW ENHANCING FEATURES,” filed Apr. 10, 2002, and Ser. No. 10/364,284, entitled “HIGH-PRESSURE PROCESSING CHAMBER FOR A SEMICONDUCTOR WAFER,” filed Feb. 10, 2003, the contents of which are incorporated herein by reference.

The controller 180 can be coupled to the process module 110, the recirculation system 120, the process chemistry supply system 130, the high-pressure fluid supply system 140, the fluid supply subassembly 142, the pressure control system 150, and the exhaust system 160. Alternately, controller 180 can be coupled to one or more additional controllers/computers (not shown), and controller 180 can obtain setup, configuration, and/or recipe information from an additional controller/computer.

In FIG. 1, singular processing elements (110, 120, 130, 140, 142, 150, 160, and 180) are shown, but this is not required for the invention. The semiconductor processing system 100 can comprise any number of processing elements having any number of controllers associated with them in addition to independent processing elements.

The controller 180 can be used to configure any number of processing elements (110, 120, 130, 140, 142, 150, and 160), and the controller 180 can collect, provide, process, store, and display data from processing elements. The controller 180 can comprise any number of applications for controlling one or more of the processing elements. For example, controller 180 can include GUI a (Graphical User Interface) component (not shown) that can provide easy to use interfaces that enable a user to monitor and/or control one or more processing elements.

The process module 110 can include an upper assembly 112, a frame 114, and a lower assembly 116. In an alternate embodiment, a frame in not required, and the upper assembly 112 can be coupled to the lower assembly 116. The upper assembly 112 can comprise a heater (not shown) for heating the process chamber, the substrate, or the processing fluid, or a combination of two or more thereof. Alternately, a heater is not required in the upper assembly 112. In another embodiment, the lower assembly 116 can comprise a heater (not shown) for heating the process chamber, the substrate, or the processing fluid, or a combination of two or more thereof. The process module 110 can include means for flowing a processing fluid through the processing chamber 108. In one example, a circular flow pattern can be established, and in another example, a substantially linear flow pattern can be established. Alternately, the means for flowing can be configured differently. For example, the lower assembly 116 can comprise one or more lifters (not shown) for moving the chuck 118 and/or the substrate 105. Alternately, a lifter is not required.

In one embodiment, the process module 110 can include a holder or chuck 118 for supporting and holding the substrate 105 while processing the substrate 105. The holder or chuck 118 can also be configured to heat or cool the substrate 105 before, during, and/or after processing the substrate 105. Alternately, the process module 110 can include a platen for supporting and holding the substrate 105 while processing the substrate 105.

A transfer system (not shown) can be used to move a substrate 105 into and out of the processing chamber 108 through a slot (not shown). In one example, the slot can be opened and closed by moving the chuck, and in another example, the slot can be controlled using a gate valve.

The substrate 105 can include semiconductor material, metallic material, dielectric material, ceramic material, or polymeric material, or a combination of two or more thereof. The semiconductor material can include elements of Si, Ge, Si/Ge, or GaAs. The metallic material can include elements of Cu, Al, Ni, Pb, Ti, Ta, or W, or combinations of two or more thereof. The dielectric material can include elements of Si, O, N, or C, or combinations of two or more thereof. The ceramic material can include elements of Al, N, Si, C, or O, or combinations of two or more thereof.

In one embodiment, the recirculation system 120 can be coupled to the process module 110 using one or more inlet lines 122 and one or more outlet lines 124, and a recirculation loop 115 can be configured that includes a portion of the recirculation system 120, a portion of the process module 110, one or more of the inlet lines 122, and one or more of the outlet lines 124. In one embodiment, the recirculation loop 115 comprises a volume of approximately one liter. In alternate embodiments, the volume of the recirculation loop 115 can vary from approximately 0.5 liters to approximately 2.5 liters.

The recirculation system 120 can comprise one or more pumps (not shown) that can be used to regulate the flow of the supercritical processing solution through the processing chamber 108 and the other elements in the recirculation loop 115. The flow rate can vary from approximately 0.01 liters/minute to approximately 100 liters/minute.

The recirculation system 120 can comprise one or more valves (not shown) for regulating the flow of a supercritical processing solution through the recirculation loop 115. For example, the recirculation system 120 can comprise any number of back-flow valves, filters, pumps, and/or heaters (not shown) for maintaining a supercritical processing solution and flowing the supercritical process solution through the recirculation system 120 and through the processing chamber 108 in the process module 110.

Processing system 100 can comprise the process chemistry supply system 130. In the illustrated embodiment, the process chemistry supply system 130 is coupled to the recirculation system 120 using one or more lines 135, but this is not required for the invention. In alternate embodiments, the process chemistry supply system 130 can be configured differently and can be coupled to different elements in the processing system.

The process chemistry is introduced by the process chemistry supply system 130 into the fluid introduced by the high-pressure fluid supply system 140 at ratios that vary with the substrate properties, the chemistry being used, and the process being performed in the processing module 110. The ratio can vary from approximately 0.001 to approximately 15 percent by volume. For example, when the recirculation loop 115 comprises a volume of about one liter, the process chemistry volumes can range from approximately ten microliters to approximately one hundred fifty milliliters. In alternate embodiments, the volume and/or the ratio can be higher or lower.

The process chemistry supply system 130 can comprise a cleaning chemistry assembly (not shown) for providing cleaning chemistry for generating supercritical cleaning solutions within the processing chamber 108. The cleaning chemistry can include peroxides and a fluoride source. For example, the peroxides can include hydrogen peroxide, benzoyl peroxide, or any other suitable peroxide, and the fluoride sources can include fluoride salts (such as ammonium fluoride salts), hydrogen fluoride, fluoride adducts (such as organic-ammonium fluoride adducts) and combinations thereof.

Further details of fluoride sources and methods of generating supercritical processing solutions with fluoride sources are described in U.S. patent application Ser. No. 10/442,557, filed May 10, 2003, and titled “TETRA-ORGANIC AMMONIUM FLUORIDE AND HF IN SUPERCRITICAL FLUID FOR PHOTORESIST AND RESIDUE REMOVAL”, and U.S. patent application Ser. No. 10/321,341, filed Dec. 16, 2002, and titled “FLUORIDE IN SUPERCRITICAL FLUID FOR PHOTORESIST POLYMER AND RESIDUE REMOVAL,” both are incorporated by reference herein.

In addition, the cleaning chemistry can include chelating agents, complexing agents, oxidants, organic acids, and inorganic acids that can be introduced into supercritical carbon dioxide with one or more carrier solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such a methanol, ethanol and 1-propanol).

Furthermore, the cleaning chemistry can include solvents, co-solvents, surfactants, and/or other ingredients. Examples of solvents, co-solvents, and surfactants are disclosed in co-owned U.S. Pat. No. 6,500,605, entitled “REMOVAL OF PHOTORESIST AND RESIDUE FROM SUBSTRATE USING SUPERCRITICAL CARBON DIOXIDE PROCESS”, issued Dec. 31, 2002, and U.S. Pat. No. 6,277,753, entitled “REMOVAL OF CMP RESIDUE FROM SEMICONDUCTORS USING SUPERCRITICAL CARBON DIOXIDE PROCESS”, issued Aug. 21, 2001, both are incorporated by reference herein.

The chemistry supply system 130 can be configured to introduce N-methylpyrrolidone (NMP), diglycol amine, hydroxylamine, di-isopropyl amine, tri-isoprpyl amine, tertiary amines, catechol, ammonium fluoride, ammonium bifluoride, methylacetoacetamide, ozone, propylene glycol monoethyl ether acetate, acetylacetone, dibasic esters, ethyl lactate, CHF₃, BF₃, HF, other fluorine containing chemicals, or any mixture thereof. Other chemicals such as organic solvents can be utilized independently or in conjunction with the above chemicals to remove organic materials. The organic solvents can include, for example, an alcohol, ether, and/or glycol, such as acetone, diacetone alcohol, dimethyl sulfoxide (DMSO), ethylene glycol, methanol, ethanol, propanol, or isopropanol (IPA). For further details, see U.S. Pat. No. 6,306,564B1, filed May 27, 1998, and titled “REMOVAL OF RESIST OR RESIDUE FROM SEMICONDUCTORS USING SUPERCRITICAL CARBON DIOXIDE”, and U.S. Pat. No. 6,509,141B2, filed Sep. 3, 1999, and titled “REMOVAL OF PHOTORESIST AND PHOTORESIST RESIDUE FROM SEMICONDUCTORS USING SUPERCRITICAL CARBON DIOXIDE PROCESS”, both are incorporated by reference herein.

Moreover, the chemistry supply system 130 can be configured to introduce a peroxide during a cleaning and/or rinsing process. The peroxide can be introduced with any one of the above process chemistries, or any mixture thereof. The peroxide can include organic peroxides, or inorganic peroxides, or a combination thereof. For example, organic peroxides can include 2-butanone peroxide; 2,4-pentanedione peroxide; peracetic acid; t-butyl hydroperoxide; benzoyl peroxide; or m-chloroperbenzoic acid (mCPBA). Other peroxides can include hydrogen peroxide. Alternatively, the peroxide can include a diacyl peroxide, such as: decanoyl peroxide; lauroyl peroxide; succinic acid peroxide; or benzoyl peroxide; or any combination thereof. Alternatively, the peroxide can include a dialkyl peroxide, such as: dicumyl peroxide; 2,5-di(t-butylperoxy)-2,5-dimethylhexane; t-butyl cumyl peroxide; α,α-bis(t-butylperoxy)diisopropylbenzene mixture of isomers; di(t-amyl) peroxide; di(t-butyl) peroxide; or 2,5-di(t-butylperoxy)-2,5-dimethyl-3-hexyne; or any combination thereof. Alternatively, the peroxide can include a diperoxyketal, such as: 1,1-di(t-butylperoxy)-3,3,5-trimethylcyclohexane; 1,1-di(t-butylperoxy)cyclohexane; 1,1-di(t-amylperoxy)-cyclohexane; n-butyl 4,4-di(t-butylperoxy)valerate; ethyl 3,3-di-(t-amylperoxy)butanoate; t-butyl peroxy-2-ethylhexanoate; or ethyl 3,3-di(t-butylperoxy)butyrate; or any combination thereof. Alternatively, the peroxide can include a hydroperoxide, such as: cumene hydroperoxide; or t-butyl hydroperoxide; or any combination thereof. Alternatively, the peroxide can include a ketone peroxide, such as: methyl ethyl ketone peroxide; or 2,4-pentanedione peroxide; or any combination thereof. Alternatively, the peroxide can include a peroxydicarbonate, such as: di(n-propyl)peroxydicarbonate; di(sec-butyl)peroxydicarbonate; or di(2-ethylhexyl)peroxydicarbonate; or any combination thereof. Alternatively, the peroxide can include a peroxyester, such as: 3-hydroxyl-1,1-dimethylbutyl peroxyneodecanoate; α-cumyl peroxyneodecanoate; t-amyl peroxyneodecanoate; t-butyl peroxyneodecanoate; t-butyl peroxypivalate; 2,5-di(2-ethylhexanoylperoxy)-2,5-dimethylhexane; t-amyl peroxy-2-ethylhexanoate; t-butyl peroxy-2-ethylhexanoate; t-amyl peroxyacetate; t-butyl peroxyacetate; t-butyl peroxybenzoate; OO-(t-amyl)O-(2-ethylhexyl)monoperoxycarbonate; OO-(t-butyl)O-isopropyl monoperoxycarbonate; OO-(t-butyl)O-(2-ethylhexyl)monoperoxycarbonate; polyether poly-t-butylperoxy carbonate; or t-butyl peroxy-3,5,5-trimethylhexanoate; or any combination thereof. Alternatively, the peroxide can include any combination of peroxides listed above.

The chemistry supply system 130 can comprise a rinsing chemistry assembly (not shown) for providing rinsing chemistry for generating supercritical rinsing solutions within the processing chamber 108. The rinsing chemistry can include one or more organic solvents including, but not limited to, alcohols and ketones. For example, the rinsing chemistry can comprise solvents, such as N,N-dimethylacetamide (DMAc), gamma-butyrolactone (BLO), dimethyl sulfoxide (DMSO), ethylene carbonate (EC), N-methylpyrrolidone (NMP), dimethylpiperidone, propylene carbonate, and alcohols (such as methanol, ethanol and 2-propanol).

Moreover, the chemistry supply system 130 can be configured to introduce treating chemistry for curing, cleaning, healing (or restoring the dielectric constant of low-k materials), or sealing, or any combination of, low dielectric constant films (porous or non-porous). The chemistry can include hexamethyldisilazane (HMDS), chlorotrimethylsilane (TMCS), trichloromethylsilane (TCMS), dimethylsilyldiethylamine (DMSDEA), tetramethyldisilazane (TMDS), trimethylsilyldimethylamine (TMSDMA), dimethylsilyldimethylamine (DMSDMA), trimethylsilyldiethylamine (TMSDEA), bistrimethylsilyl urea (BTSU), bis(dimethylamino)methyl silane (B[DMA]MS), bis (dimethylamino)dimethyl silane (B[DMA]DS), HMCTS, dimethylaminopentamethyldisilane (DMAPMDS), dimethylaminodimethyldisilane (DMADMDS), disila-aza-cyclopentane (TDACP), disila-oza-cyclopentane (TDOCP), methyltrimethoxysilane (MTMOS), vinyltrimethoxysilane (VTMOS), or trimethylsilylimidazole (TMSI). Additionally, the chemistry can include N-tert-butyl-1,1-dimethyl-1-(2,3,4,5-tetramethyl-2,4-cyclopentadiene-1-yl) silanamine, 1,3-diphenyl-1,1,3,3-tetramethyldisilazane, or tert-butylchlorodiphenylsilane. For further details, see U.S. patent application Ser. No. 10/682,196, filed Oct. 10, 2003, and titled “METHOD AND SYSTEM FOR TREATING A DIELECTRIC FILM”, and U.S. patent application Ser. No. 10/379,984, filed Mar. 4, 2003, and titled “METHOD OF PASSIVATING LOW DIELECTRIC MATERIALS IN WAFER PROCESSING”, both incorporated by reference herein.

The processing system 100 can comprise a high-pressure fluid supply system 140. As shown in FIG. 1, the high-pressure fluid supply system 140 can be coupled to the recirculation system 120 using one or more lines 145, but this is not required. The inlet line 145 can be equipped with one or more back-flow valves, and/or heaters (not shown) for controlling the fluid flow from the high-pressure fluid supply system 140. In alternate embodiments, high-pressure fluid supply system 140 can be configured differently and coupled differently. For example, the high-pressure fluid supply system 140 can be coupled to the process module 110.

The high-pressure fluid supply system 140 can comprise a carbon dioxide source (not shown) and a plurality of flow control elements (not shown) for generating a supercritical fluid. For example, the carbon dioxide source can include a CO₂ feed system, and the flow control elements can include supply lines, valves, filters, pumps, and heaters. The high-pressure fluid supply system 140 can comprise an inlet valve (not shown) that is configured to open and close to allow or prevent the stream of supercritical carbon dioxide from flowing into the processing chamber 108. For example, controller 180 can be used to determine fluid parameters such as pressure, temperature, process time, and flow rate.

The processing system 100 can also comprise a pressure control system 150. As shown in FIG. 1, the pressure control system 150 can be coupled to the process module 110 using one or more lines 155, but this is not required. Line 155 can be equipped with one or more back-flow valves, pumps, and/or heaters (not shown) for controlling the fluid flow to pressure control system 150. In alternate embodiments, pressure control system 150 can be configured differently and coupled differently. For example, the pressure control system 150 can also include one or more pumps (not shown), and a sealing means (not shown) for sealing the processing chamber 108. In addition, the pressure control system 150 can comprise means for raising and lowering the substrate 105 and/or the chuck 118.

In addition, the processing system 100 can comprise an exhaust control system 160. Alternately, an exhaust system may not be required. As shown in FIG. 1, the exhaust control system 160 can be coupled to the process module 110 using one or more lines 165, but this is not required. Line 165 can be equipped with one or more back-flow valves, and/or heaters (not shown) for controlling the fluid flow to the exhaust control system 160. In alternate embodiments, exhaust control system 160 can be configured differently and coupled differently. The exhaust control system 160 can include an exhaust gas collection vessel (not shown) and can be used to remove contaminants from the processing fluid. Alternately, the exhaust control system 160 can be used to recycle the processing fluid.

Furthermore, the processing system 100 can comprise a fluid supply subassembly 142. As shown in the illustrated embodiment, the fluid supply subassembly 142 is configured within the high-pressure fluid supply system 140 and is coupled to the process module 110 using one or more lines 145. The fluid supply subassembly 142 can comprise means (not shown) for providing temperature-controlled fluid to the processing chamber 108 and other elements in the recirculation loop 115.

In one embodiment, controller 180 can comprise a processor 182 and a memory 184. Memory 184 can be coupled to processor 182, and can be used for storing information and instructions to be executed by processor 182. Alternately, different controller configurations can be used. In addition, controller 180 can comprise a port 185 that can be used to couple processing system 100 to another system (not shown). Furthermore, controller 180 can comprise input and/or output devices (not shown).

In addition, one or more of the processing elements (110, 120, 130, 140, 150, 160, and 180) can include memory (not shown) for storing information and instructions to be executed during processing and processors for processing information and/or executing instructions. For example, the memory can be used for storing temporary variables or other intermediate information during the execution of instructions by the various processors in the system. One or more of the processing elements can comprise the means for reading data and/or instructions from a computer readable medium. In addition, one or more of the processing elements can comprise the means for writing data and/or instructions to a computer readable medium.

Memory devices can include at least one computer readable medium or memory for holding computer-executable instructions programmed according to the teachings of the invention and for containing data structures, tables, records, or other data described herein.

The processing system 100 can perform a portion or all of the processing steps of the invention in response to the controller 180 executing one or more sequences of one or more computer-executable instructions contained in a memory. Such instructions can be received by the controller 180 from another computer, a computer readable medium, or a network connection.

Stored on any one or on a combination of computer readable media, the present invention includes software for controlling the processing system 100, for driving a device or devices for implementing the invention, and for enabling the processing system 100 to interact with a human user and/or another system, such as a factory system. Such software can include, but is not limited to, device drivers, operating systems, development tools, and applications software. Such computer readable media further includes the computer program product of the present invention for performing all or a portion (if processing is distributed) of the processing performed in implementing the invention.

The term “computer readable medium” as used herein refers to any medium that participates in providing instructions to a processor for execution and/or that participates in storing information before, during, and/or after executing an instruction. A computer readable medium can take many forms, including but not limited to, non-volatile media, volatile media, and transmission media. The term “computer-executable instruction” as used herein refers to any computer code and/or software that can be executed by a processor, that provides instructions to a processor for execution and/or that participates in storing information before, during, and/or after executing an instruction.

Controller 180, processor 182, memory 184 and other processors and memory in other system elements as described thus far can, unless indicated otherwise below, be constituted by components known in the art or constructed according to principles known in the art. The computer readable medium and the computer executable instructions can also, unless indicated otherwise below, be constituted by components known in the art or constructed according to principles known in the art.

Controller 180 can use a port 185 to obtain computer code and/or software from another system (not shown), such as a factory system. The computer code and/or software can be used to establish a control hierarchy. For example, the processing system 100 can operate independently, or can be controlled to some degree by a higher-level system (not shown).

The controller 180 can be coupled to the fluid supply subassembly 142 and the controller 180 can include means for determining the temperature of the fluid being supplied by the fluid supply subassembly 142, means for comparing the temperature to a threshold value, and means for altering the temperature of the fluid being supplied when the temperature is different from the threshold value. For example, the temperature can be decreased when the temperature is greater than the threshold value, and the temperature can be increased when the temperature is less than the threshold value.

The controller 180 can use data from the fluid supply subassembly 142 to determine when to alter, pause, and/or stop a process. The controller 180 can use the data and operational rules to determine when to change a process and how to change the process, and rules can be used to specify the action taken for normal processing and the actions taken on exceptional conditions. For example, rules can be used to allow different temperature ranges and/or changes during different processes. Operational rules can be used to determine which processes are monitored and which data is used. For example, rules can be used to determine how to manage the data when a process is changed, paused, and/or stopped. In general, rules allow the processing system 100 and/or tool operation to change based on the dynamic state of the processing system 100.

Controller 180 can receive, send, use, and/or generate pre-process data, process data, and post-process data, and this data can include lot data, batch data, run data, composition data, and history data. Pre-process data can be associated with an incoming substrate and can be used to establish an input state for a substrate. Process data can include process parameters. Post processing data can be associated with a processed substrate and can be used to establish an output state for a substrate

The controller 180 can use the pre-process data to predict, select, or calculate a process recipe to use to process the substrate. A process recipe can include a multi-step process involving a set of process modules. Post-process data can be obtained at some point after the substrate has been processed. For example, post-process data can be obtained after a time delay that can vary from minutes to days.

In one embodiment, the controller 180 can compute a predicted state for the temperature of the fluid based on the pre-process data, the process characteristics, and a process model. A process model can provide the relationship between one or more process recipe parameters or set points and one or more process results. The controller 180 can compare the predicted value to the measured value obtained from the fluid supply subassembly 142 to determine when to alter, pause, and/or stop a process.

In another embodiment, the controller 180 can use historical data and/or process models to compute an expected value for the temperature of the fluid at various times during the process. The controller 180 can compare the expected value to the measured value obtained from the fluid supply subassembly 142 or another sensor in the system to determine when to alter, pause, and/or stop a process.

In a supercritical cleaning/rinsing process, the desired process result can be a process result that is measurable using an optical measuring device, such as a SEM and/or a TEM. For example, the desired process result can be an amount of contaminant in a via or on the surface of a substrate. After one or more cleaning process run, the desired process can be measured.

It will be appreciated that the controller 180 can perform other functions in addition to those discussed here. The controller 180 can monitor variables associated with the other components in the processing system 100 and take actions based on these variables. For example, the controller 180 can process these variables, display these variables and/or results on a GUI screen, determine a fault condition, determine a response to a fault condition, and alert an operator.

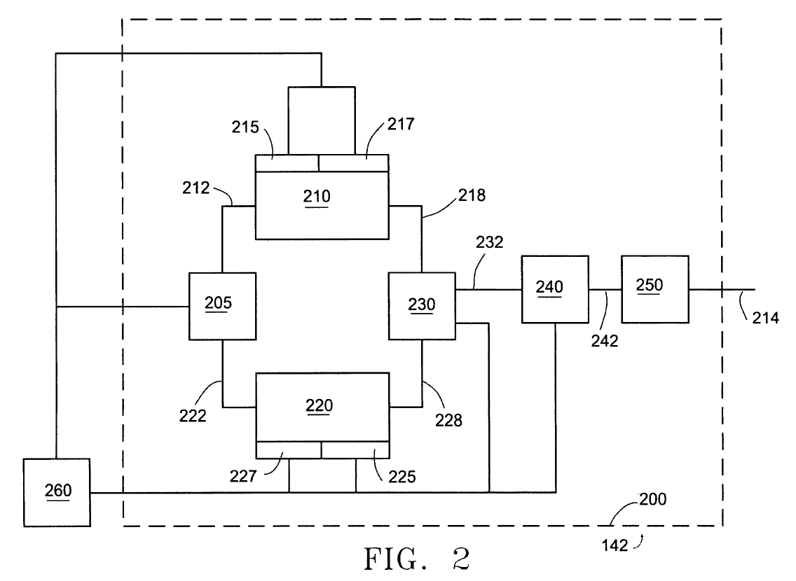

FIG. 2 illustrates a simplified block diagram of a fluid supply subassembly in accordance with an embodiment of the invention. In the illustrated embodiment, a fluid supply subassembly 142 is shown that includes a fluid supply 205, a first temperature control element 210, a second temperature control element 220, a fluid mixing element 230, a fluid measurement element 240, a output element 250, and a controller 260. In alternate embodiments, different configurations can be used. For example, the fluid supply subassembly 142 can be a portion of the fluid supply system 140 (FIG. 1).

As shown in FIG. 2, the fluid supply subassembly 142 can comprise an outlet 214 that can be used to couple the fluid supply subassembly 142 to the high-pressure fluid supply system (140 FIG. 1). For example, the fluid supply subassembly 142 can be coupled into the flow path through the high-pressure fluid supply system (140 FIG. 1). Alternately, the fluid supply subassembly 142 may be coupled to can be coupled into the flow path differently. In another embodiment, the outlet 214 may not be required.

In addition, the fluid supply 205 can be coupled to first temperature control element 210 and the second temperature control element 220. The first temperature control element 210 and the second temperature control element 220 can be coupled to the mixing element 230, and the mixing element 230 can be coupled to the fluid measurement element 240. The fluid measurement element 240 can be coupled to the output element 250. The controller 260 can be coupled to the fluid supply 205, the first temperature control element 210, the second temperature control element 220, the mixing element 230, the fluid measurement element 240, and the output element 250. The output element 250 can be used to control the flow of fluid through the outlet 214. In an alternate embodiment, the output element 250 may not be required.

The fluid supply subassembly 142 can have an operating pressure up to 10,000 psi, and an operating temperature up to 300 degrees Celsius. The fluid supply subassembly 142 can be used to provide a temperature controlled supercritical fluid that can include supercritical carbon dioxide. In an alternate embodiment, the fluid supply subassembly 142 can be used to provide a temperature controlled supercritical fluid that can include supercritical carbon dioxide admixed with process chemistry.

The fluid supply 205 can provide a process fluid that can comprise gaseous, liquid, supercritical, or near-supercritical carbon dioxide, or combinations thereof. The fluid supply 205 can include a supply system, one or more fluid cylinders, and/or one or more storage vessels (not shown). In an alternate embodiment, different fluid source configurations can be used without departing from the spirit and scope of the invention. For example, separate sources can be provided for the each temperature control element 210 and 220. In addition, the fluid supply 205 can include a heater, a valve, a pump, a sensor, a coupling, a filter, and/or piping (not shown). In another embodiment, the fluid supply 205 can include a controller.

Pipe 212 can be used to couple fluid supply 205 to the first temperature control element 210, and pipe 222 can be used to couple fluid supply 205 to the second temperature control element 220. In an alternate embodiment, the pipe 212 and/or pipe 222 can include a heater, a valve, a pump, a sensor, a coupling, a filter, and/or piping (not shown).

The first temperature control element 210 can include a heater 215 for controlling the temperature of the fluid passing therethrough. In an alternate embodiment, the first temperature control element 210 can include a cooling device (not shown). In addition, the second temperature control element 220 can include a heater 225 for controlling the temperature of the fluid passing therethrough. In an alternate embodiment, the second temperature control element 220 can include a cooling device (not shown).

The first temperature control element 210 can include a measuring means 217 for measuring the temperature of the fluid passing therethrough. In an alternate embodiment, the first temperature control element 210 may not include a measuring means 217. In addition, the second temperature control element 220 can include a measuring means 227 for measuring the temperature of the fluid passing therethrough. In an alternate embodiment, the second temperature control element 220 may not include a measuring means 227.

Pipe 218 can be used to couple the mixing element 230 to the first temperature control element 210, and pipe 228 can be used to couple the mixing element 230 to the second temperature control element 220. Alternately, pipe 218 and/or 228 may not be required. In other embodiments, the pipe 212 and/or pipe 222 can include heaters, valves, pumps, sensors, couplings, filters, and/or pipes (not shown).

The mixing element 230 can be used to control the flow of fluid into the output element 250. The fluid can be fluid at a first temperature from the first temperature control element 210, fluid at a second temperature from the second temperature control element 220, or fluid at a third temperature that is a mixture of fluid from the first temperature control element 210 and fluid from the second temperature control element 220. Pipe 232 can be used to couple the mixing element 230 to the fluid measurement element 240. Alternately, pipe 232 may not be required. In other embodiments, mixing element 230 and/or pipe 232 can include heaters, valves, pumps, sensors, couplings, filters, and/or pipes (not shown).

In one embodiment, mixing element 230 can comprise a flow control valve (not shown). For example, a multi-port valve can be used. In alternate embodiments, mixing element 230 can comprise a mixing vessel (not shown) and/or a storage vessel (not shown), and one or more vessels can be heated.

The fluid measurement element 240 can be used to measure the temperature of fluid passing through the output element 250. Alternately, the fluid measurement element 240 can be used to measure the flow and/or pressure of fluid passing through the output element 250. In other embodiments, a fluid measurement element 240 may not be required. For example, measurements can be made by mixing element 230 and/or output element 250. Pipe 242 can be used to couple the fluid measurement element 240 to the output element 250 of the fluid supply subassembly 142. Alternately, pipe 242 may not be required. In other embodiments, fluid measurement element 240 and/or pipe 242 can include heaters, valves, pumps, sensors, couplings, filters, and/or pipes (not shown).

Controller 260 can be used to control the fluid supply subassembly 142, and controller 260 can be coupled to controller 180 (FIG. 1). Alternately, controller 260 may not be required. For example, controller 180 can be used to control the fluid supply subassembly 142.

Controller 260 can be used to determine and control the temperature of the fluid from the first temperature control element 210, can be used to determine and control the temperature of the fluid from the second temperature control element 220, and can be used to determine and control the temperature of the fluid from the outlet 214 of the fluid supply subassembly 142.

Controller 260 can be used to determine and control the flow rate and/or pressure of the fluid from the first temperature control element 210, can be used to determine and control the flow rate and/or pressure of the fluid from the second temperature control element 220, and can be used to determine and control the flow rate and/or pressure of the fluid from the outlet 214 of the fluid supply subassembly 142. Controller 260 can control the mixing rate of the fluid from the first temperature control element 210 and fluid from the second temperature control element 220. In alternate embodiments, controller 260 can be used to control the temperature of the fluid supply 205, the mixing element 230, and/or the fluid measurement element 240.

During substrate processing, providing processing fluids at an incorrect temperature can have a negative affect on the process. For example, an incorrect temperature can affect the process chemistry, process dropout, and process uniformity. In one embodiment, the fluid supply subassembly 142 can be coupled into the flow path during a major portion of the substrate processing so that the impact of temperature on the process is minimized.

In another embodiment, fluid supply subassembly 142 can be used during a maintenance or system cleaning operation in which cleaning chemistry is used to remove process by-products and/or particles from the interior surfaces of the system. This is a preventative maintenance operation in which maintaining the correct temperature prevents material from adhering to the interior surfaces of the system that can be dislodged later during processing and that can cause unwanted particle deposition on a substrate.

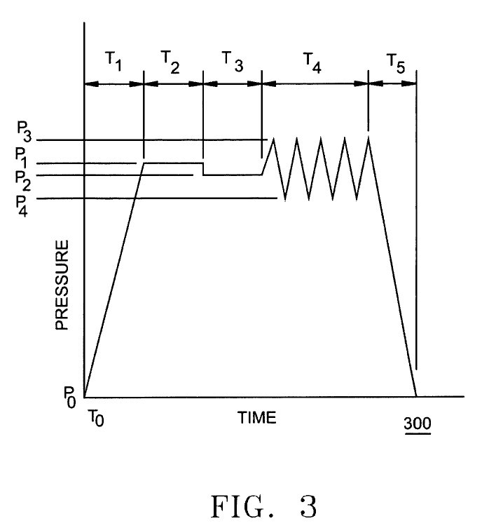

FIG. 3 illustrates an exemplary graph of pressure versus time for a supercritical process step in accordance with an embodiment of the invention. In the illustrated embodiment, a graph 300 of pressure versus time is shown, and the graph 300 can be used to represent a supercritical cleaning process step, a supercritical rinsing process step, or a supercritical curing process step, or a combination thereof. Alternately, different pressures, different timing, and different sequences can be used for different processes. In addition, although a single time sequence is illustrated in FIG. 3, this is not required for the invention. Alternately, multi-sequence processes can be used.

Referring to FIGS. 1, 2, and 3, prior to an initial time T₀, the substrate to be processed can be placed within the processing chamber 108 and the processing chamber 108 can be sealed. For example, during cleaning and/or rinsing processes, a substrate can have post-etch and/or post-ash residue thereon. The substrate, the processing chamber, and the other elements in the recirculation loop 115 can be heated to an operational temperature. For example, the operational temperature can range from 40 to 300 degrees Celsius.

During time T₁, the processing chamber 108 and the other elements in the recirculation loop 115 can be pressurized. During at least one portion of the time T₁, the fluid supply subassembly 142 can be coupled into the flow path and can be used to provide temperature controlled carbon dioxide into the processing chamber 108 and/or other elements in the recirculation loop 115.

In one embodiment, the fluid supply subassembly 142 can be operated during a pressurization process and can be used to fill the recirculation loop 115 with temperature-controlled fluid. The fluid supply subassembly can comprise means for filling the recirculation loop with the temperature-controlled fluid, and the temperature variation of the temperature-controlled fluid can be controlled to be less than approximately ten degrees Celsius during the pressurization process. Alternately, the temperature variation of the temperature-controlled fluid can be controlled to be less than approximately five degrees Celsius during the pressurization process.

For example, a supercritical fluid, such as substantially pure CO₂, can be used to pressurize the processing chamber 108 and the other elements in the recirculation loop 115. During time T₁, a pump (not shown) in the recirculation system 120 FIG. 1) can be started and can be used to circulate the temperature controlled fluid through the processing chamber 108 and the other elements in the recirculation loop 115.

In one embodiment, when the pressure in the processing chamber 108 exceeds a critical pressure Pc (1,070 psi), process chemistry can be injected into the processing chamber 108, using the process chemistry supply system 130. In one embodiment, the fluid supply subassembly 142 can be switched off before the process chemistry is injected. Alternately, the fluid supply subassembly 142 can be switched on while the process chemistry is being injected.

In other embodiments, process chemistry can be injected into the processing chamber 108 before the pressure exceeds the critical pressure Pc (1,070 psi) using the process chemistry supply system 130. For example, the injection(s) of the process chemistries can begin upon reaching about 1100-1200 psi. In other embodiments, process chemistry is not injected during the T₁ period.

In one embodiment, process chemistry is injected in a linear fashion, and the injection time can be based on a recirculation time. For example, the recirculation time can be determined based on the length of the recirculation path and the flow rate. In other embodiments, process chemistry can be injected in a non-linear fashion. For example, process chemistry can be injected in one or more steps.

The process chemistry can include a cleaning agent, a rinsing agent, or a curing agent, or a combination thereof that is injected into the supercritical fluid. One or more injections of process chemistries can be performed over the duration of time T₁ to generate a supercritical processing solution with the desired concentrations of chemicals. The process chemistry, in accordance with the embodiments of the invention, can also include one more or more carrier solvents.

Still referring to FIGS. 1, 2, and 3, during a second time T₂, the supercritical processing solution can be re-circulated over the substrate and through the processing chamber 108, and the other elements in the recirculation loop 115 using the recirculation system 120, such as described herein. In one embodiment, the fluid supply subassembly 142 can be switched off, and process chemistry is not injected during the second time T₂. Alternatively, the fluid supply subassembly 142 can be switched on, and process chemistry can be injected into the processing chamber 108 during the second time T₂ or after the second time T₂.

The processing chamber 108 can operate at a pressure above 1,500 psi during the second time T₂. For example, the pressure can range from approximately 2,500 psi to approximately 3,100 psi, but can be any value so long as the operating pressure is sufficient to maintain supercritical conditions. The supercritical processing solution can be circulated over the substrate and through the processing chamber 108 using the recirculation system 120. The supercritical conditions within the processing chamber 108 and the other elements in the recirculation loop 115 are maintained during the second time T₂, and the supercritical processing solution continues to be circulated over the substrate and through the processing chamber 108 and the other elements in the recirculation loop 115. The recirculation system 120 can be used to regulate the flow of the supercritical processing solution through the processing chamber 108 and the other elements in the recirculation loop 115.

Still referring to FIGS. 1, 2, and 3, during a third time T₃, one or more push-through processes can be performed. The fluid supply subassembly 142 can comprise means for providing a first volume of temperature-controlled fluid during a push-through process, and the first volume can be larger than the volume of the recirculation loop 115. Alternately, the first volume can be less than or approximately equal to the volume of the recirculation loop 115. In addition, the temperature differential within the first volume of temperature-controlled fluid during the push-through process can be controlled to be less than approximately ten degrees Celsius. Alternately, the temperature variation of the temperature-controlled fluid can be controlled to be less than approximately five degrees Celsius during a push-through process.

In one embodiment, the controller 180 can operate during a push-through process. Alternately, the controller 180 may not be operated during a push-through process. The controller 180 can be used to control the temperature and/or volume of fluid provided by the fluid supply subassembly 142 during a push-through process. For example, during the third time T₃, one or more volumes of temperature controlled supercritical carbon dioxide can be fed into the processing chamber 108 and the other elements in the recirculation loop 115 from the fluid supply subassembly 142, and the supercritical processing solution along with process residue suspended or dissolved therein can be displaced from the processing chamber 108 and the other elements in the recirculation loop 115 through the exhaust control system 160. For example, supercritical carbon dioxide can be fed into the recirculation system 120 from the fluid supply subassembly 142, and the supercritical processing solution along with process residue suspended or dissolved therein can also be displaced from the processing chamber 108 and the other elements in the recirculation loop 115 through the exhaust control system 160.

Providing temperature-controlled fluid during the push-through process prevents process residue suspended or dissolved within the fluid being displaced from the processing chamber 108 and the other elements in the recirculation loop 115 from dropping out and/or adhering to the processing chamber 108 and the other elements in the recirculation loop 115. In addition, during the third time T₃, the temperature of the fluid supplied by the fluid supply subassembly 142 can vary over a wider temperature range than the range used during the second time T₂.

In the illustrated embodiment shown in FIG. 3, a single second time T₂ is followed by a single third time T₃, but this is not required. In alternate embodiments, other time sequences can be used to process a substrate.

After the push-through process is complete, a pressure cycling process can be performed. Alternately, one or more pressure cycles can occur during the push-through process. In other embodiments, a pressure cycling process is not required. During a fourth time T₄, the processing chamber 108 can be cycled through a plurality of decompression and compression cycles. The pressure can be cycled between a first pressure P₃ and a second pressure P₄ one or more times. In alternate embodiments, the first pressure P₃ and a second pressure P₄ can vary. In one embodiment, the pressure can be lowered by venting through the exhaust control system 160. For example, this can be accomplished by lowering the pressure to below approximately 1,500 psi and raising the pressure to above approximately 2,500 psi. The pressure can be increased by using the fluid supply subassembly 142 to provide additional high-pressure fluid.

The fluid supply subassembly can comprise means for providing a first volume of temperature-controlled fluid during a compression cycle, and the first volume can be larger than the volume of the recirculation loop 115. Alternately, the first volume can be less than or approximately equal to the volume of the recirculation loop 115. In addition, the temperature differential within the first volume of temperature-controlled fluid during the compression cycle can be controlled to be less than approximately ten degrees Celsius. Alternately, the temperature variation of the temperature-controlled fluid can be controlled to be less than approximately five degrees Celsius during a compression cycle.

In addition, the fluid supply subassembly 142 can comprise means for providing a second volume of temperature-controlled fluid during a decompression cycle, and the second volume can be larger than the volume of the recirculation loop 115. Alternately, the second volume can be less than or approximately equal to the volume of the recirculation loop 115. In addition, the temperature differential within the second volume of temperature-controlled fluid during the decompression cycle can be controlled to be less than approximately ten degrees Celsius. Alternately, the temperature variation of the temperature-controlled fluid can be controlled to be less than approximately five degrees Celsius during a decompression cycle.

In other embodiments, the fluid supply subassembly can comprise means for providing one or more volumes of temperature controlled fluid during a compression cycle and/o decompression cycle; each volume can be larger than the volume of the processing chamber or the volume of the recirculation loop; the temperature variation associated with each volume can be controlled to be less than 10 degrees Celsius; and the temperature variation can be allowed to increase as additional cycles are performed.

In one embodiment, the controller 180 can operate during a pressure cycling process. The controller 180 can be used to control the temperature of the supplied fluid, the volume of fluid, and/or the supply times for the fluid provided by the fluid supply subassembly 142 during a pressure cycling process. Alternately, the controller may not be operated during a pressure cycling process. For example, during the fourth time T₄, one or more volumes of temperature controlled supercritical carbon dioxide can be fed into the processing chamber 108 and the other elements in the recirculation loop 115 from the fluid supply subassembly 142, and the supercritical processing solution along with process residue suspended or dissolved therein can be displaced from the processing chamber 108 and the other elements in the recirculation loop 115 through the exhaust control system 160. A monitoring system can be used to measure the process residue in the processing solution before, during, and/or after a pressure cycling process.

Providing temperature-controlled fluid during the pressure cycling process prevents process residue suspended or dissolved within the fluid being displaced from the processing chamber 108 and the other elements in the recirculation loop 115 from dropping out and/or adhering to the processing chamber 108 and the other elements in the recirculation loop 115. In addition, during the fourth time T₄, the temperature of the fluid supplied by the fluid supply subassembly 142 can vary over a wider temperature range than the range used during the second time T₂.

In the illustrated embodiment shown in FIG. 3, a single third time T₃ is followed by a single fourth time T₄, but this is not required. In alternate embodiments, other time sequences can be used to process a substrate.

In an alternate embodiment, the fluid supply subassembly 142 can be switched off during a portion of the fourth time T₄. For example, the fluid supply subassembly 142 can be switched off during a decompression cycle.

During a fifth time T₅, the processing chamber 108 can be returned to lower pressure. For example, after the pressure cycling process is completed, then the processing chamber 108 can be vented or exhausted to atmospheric pressure.

The fluid supply subassembly 142 can comprise means for providing a volume of temperature-controlled fluid during a venting process, and the volume can be larger than the volume of the recirculation loop. Alternately, the volume can be less than or approximately equal to the volume of the recirculation loop. In addition, the temperature differential within the volume of temperature-controlled fluid during the venting process can be controlled to be less than approximately 20 degrees Celsius. Alternately, the temperature variation of the temperature-controlled fluid can be controlled to be less than approximately 15 degrees Celsius during a venting process.

In other embodiments, the fluid supply subassembly 142 can comprise means for providing one or more volumes of temperature controlled fluid during a venting process; each volume can be larger than the volume of the processing chamber 108 or the volume of the recirculation loop 115; the temperature variation associated with each volume can be controlled to be less than 20 degrees Celsius; and the temperature variation can be allowed to increase as the pressure approaches the final pressure.

Furthermore, during the fifth time T₅, one or more volumes of temperature controlled supercritical carbon dioxide can be fed into the processing chamber 108 and the other elements in the recirculation loop 115 from the fluid supply subassembly 142, and the remaining supercritical cleaning solution along with process residue suspended or dissolved therein can be displaced from the processing chamber 108 and the other elements in the recirculation loop 115 through the exhaust control system 160. In an alternate embodiment, supercritical carbon dioxide can be fed into the recirculation system 120 from the fluid supply subassembly 142, and the remaining supercritical cleaning solution along with process residue suspended or dissolved therein can also be displaced from the processing chamber 108 and the other elements in the recirculation loop 115 through the exhaust control system 160.

Providing temperature-controlled fluid during the venting process prevents process residue suspended or dissolved within the fluid being displaced from the processing chamber 108 and the other elements in the recirculation loop 115 from dropping out and/or adhering to the processing chamber 108 and the other elements in the recirculation loop 115.

In the illustrated embodiment shown in FIG. 3, a single fourth time T₄ is followed by a single fifth time T₅, but this is not required. In alternate embodiments, other time sequences can be used to process a substrate.

In one embodiment, during a portion of the fifth time T₅, the fluid supply subassembly 142 can be switched off. In addition, the temperature of the fluid supplied by the fluid supply subassembly 142 can vary over a wider temperature range than the range used during the second time T₂. For example, the temperature can range below the temperature required for supercritical operation.

For substrate processing, the chamber pressure can be made substantially equal to the pressure inside of a transfer chamber (not shown) coupled to the processing chamber 108. In one embodiment, the substrate can be moved from the processing chamber into the transfer chamber, and moved to a second process apparatus or module to continue processing.

In the illustrated embodiment shown in FIG. 3, the pressure returns to an initial pressure P₀, but this is not required for the invention. In alternate embodiments, the pressure does not have to return to P₀, and the process sequence can continue with additional time steps such as those shown in time steps T₁, T₂, T₃, T₄, or T₅

The graph 300 is provided for exemplary purposes only. It will be understood by those skilled in the art that a supercritical processing step can have any number of different time/pressures or temperature profiles without departing from the scope of the invention. Further, any number of cleaning, rinsing, and/or curing process sequences with each step having any number of compression and decompression cycles are contemplated. In addition, as stated previously, concentrations of various chemicals and species within a supercritical processing solution can be readily tailored for the application at hand and altered at any time within a supercritical processing step.

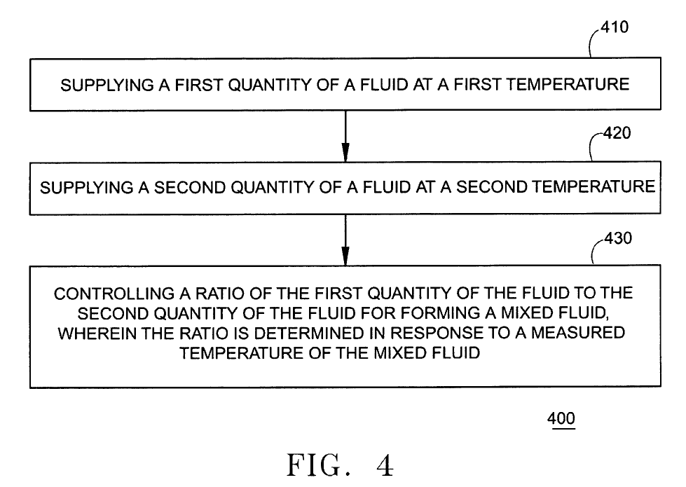

FIG. 4 illustrates a flow diagram of a method of operating a fluid supply subassembly 142 in accordance with an embodiment of the invention. In the illustrated embodiment, a procedure 400 having three steps is shown, but this is not required for the invention. Alternately, a different number of steps and/or different types of processes can be included.

In 410, a first quantity of fluid at a first temperature can be supplied. For example, the first quantity of fluid at the first temperature can be supplied to a flow control device and/or a mixing device.

In 420, a second quantity of fluid at a second temperature can be supplied. For example, the second quantity of fluid at the second temperature can be supplied to the flow control device and/or the mixing device.

In 430, a temperature-controlled fluid can be formed by controlling the ratio of the first quantity of fluid at a first temperature and the second quantity of fluid at a second temperature. In addition, the ratio can be controlled by the temperature of the temperature-controlled fluid. In one embodiment, the temperature of the temperature-controlled fluid can be measured by the fluid supply subassembly. In an alternate embodiment, the temperature of the temperature-controlled fluid can be calculated.

In one embodiment, the temperature of the temperature controlled fluid can be compared to the temperature of the fluid flowing into the processing chamber 108, the temperature of the fluid flowing in the processing chamber 108, the temperature of the processing chamber 108, or the temperature of the fluid flowing out of the processing chamber 108, or a combination thereof.

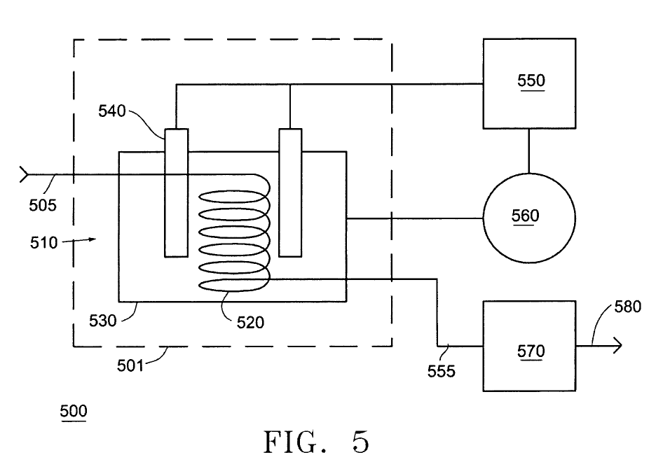

FIG. 5 illustrates a simplified block diagram of a heating device 500 for use in a fluid supply subassembly 142 in accordance with an embodiment of the invention. In the illustrated embodiment, a single unit is shown, but this is not required for the invention. Alternately, a different number of units can be used, and one or more of the heating devices can be configured differently than shown in FIG. 5.

Heating device 500 can include a heat exchanger 510, a controller 550, a measuring means 560, and a heated storage vessel 570. An input line 505 can be coupled to the heat exchanger 510, a line 555 can couple the heat exchanger 510 to the heated storage vessel 570, and an output line 580 can be coupled to the heated storage vessel 570. In one embodiment, the volume within the heated storage vessel 570 can be larger than the volume of the recirculation loop 115. In an alternate embodiment, a heated storage vessel 570 is not required.

Heat exchanger 510 can include a thermal mass 530 and one or more heating elements 540 that can be coupled to the thermal mass 530. Controller 550 can be coupled to heating elements 540, and the controller 550 can provide the necessary power and control signals to the heating elements 540.

In accordance with the embodiments of the invention, the thermal mass 530 can include a fluid (not shown) and the heat exchanger includes one or more coils 520 that can be inside the thermal mass 530. In one embodiment, the volume of the fluid can be larger than the volume of the recirculation loop 115 (FIG. 1). An input line 505 can be coupled to the thermal mass 530.

While the invention has been described in terms of specific embodiments incorporating details to facilitate the understanding of the principles of construction and operation of the invention, such reference herein to specific embodiments and details thereof is not intended to limit the scope of the claims appended hereto. It will be apparent to those skilled in the art that modifications can be made in the embodiments chosen for illustration without departing from the spirit and scope of the invention.

What is claimed is:

1. An apparatus for providing a temperature controlled fluid, comprising:
a processing chamber having a processing chamber inlet and a processing chamber outlet;
a recirculation system having an inlet coupled to the processing chamber outlet and an outlet coupled to the processing chamber inlet;
a fluid supply subassembly coupled to the processing chamber for providing the temperature controlled fluid to the processing chamber, wherein the fluid supply subassembly comprises means for supplying a first quantity of a fluid at a first temperature, means for supplying a second quantity of a fluid at a second temperature, and flow-control means coupled to the means for supplying a first quantity of a fluid at a first temperature and to the means for supplying a second quantity of a fluid at a second temperature, the flow-control means for forming the temperature controlled fluid; and
a controller coupled to the fluid supply subassembly for determining a temperature of the temperature controlled fluid and controlling a ratio of the first quantity of the fluid to the second quantity of the fluid in response to the temperature.

2. The apparatus of claim 1, wherein the flow-control means includes a flow control valve coupled to the means for supplying a first quantity of a fluid at a first temperature and to the means for supplying a second quantity of a fluid at a second temperature.

3. The apparatus of claim 1, wherein the flow-control means includes a mixing chamber coupled to the means for supplying a first quantity of a fluid at a first temperature and to the means for supplying a second quantity of a fluid at a second temperature.

4. The apparatus of claim 1, further comprising means for supplying process chemistry coupled to the flow-control means, the means for supplying the first quantity of the fluid at a first temperature, or the means for supplying the second quantity of the fluid at a second temperature, or a combination of two or more thereof.

5. The apparatus of claim 1, further comprising means for measuring temperature coupled to the flow-control means, the means for supplying the first quantity of the fluid at a first temperature, or the means for supplying the second quantity of the fluid at a second temperature, or a combination of two or more thereof.

6. The apparatus of claim 1, further comprising means for measuring fluid flow coupled to the flow-control means, the means for supplying the first quantity of the fluid at a first temperature, or the means for supplying the second quantity of the fluid at a second temperature, or a combination of two or more thereof.

7. The apparatus of claim 1, further comprising means for measuring pressure coupled to the flow-control means, the means for supplying the first quantity of the fluid at a first temperature, or the means for supplying the second quantity of the fluid at a second temperature, or a combination of two or more thereof.

8. The apparatus of claim 1 wherein the temperature controlled fluid comprises gaseous, liquid, supercritical, or near-supercritical carbon dioxide, or a combination of two or more thereof.

9. The apparatus of claim 1 wherein the temperature controlled fluid comprises solvents, co-solvents, or surfactants, or a combination of two or more thereof.

10. The apparatus of claim 1 further comprising a fluid source coupled to the flow-control means, the means for supplying the first quantity of the fluid at a first temperature, or the means for supplying the second quantity of the fluid at a second temperature, or a combination of two or more thereof.

11. The apparatus of claim 10, wherein the fluid source comprises substantially pure CO₂.

12. The apparatus of claim 1 further comprising a heating device coupled to the flow-control means, the means for supplying the first quantity of the fluid at a first temperature, or the means for supplying the second quantity of the fluid at a second temperature, or a combination of two or more thereof.

13. The apparatus of claim 11, wherein the heating device comprises a heat exchanger.

14. The apparatus of claim 13 wherein the heat exchanger comprises:
a thermal mass;
heating means for heating the thermal mass; and
fluid conveying means adapted and positioned to achieve heat transfer from the thermal mass, or the heating means, or a combination thereof.

15. The apparatus of claim 1 further comprising a heated storage vessel coupled to the flow-control means, the means for supplying the first quantity of the fluid at a first temperature, or the means for supplying the second quantity of the fluid at a second temperature, or a combination of two or more thereof.

16. The apparatus of claim 1, wherein the recirculation system, the processing chamber, and piping coupling the recirculation system to the processing chamber form a recirculation loop and the fluid supply subassembly comprises means for filling the recirculation loop with the temperature controlled fluid, wherein a temperature variation of the temperature controlled fluid during filling is less than approximately ten degrees Celsius.

17. The apparatus of claim 16, wherein the recirculation loop is configured for supercritical processing.

18. The apparatus of claim 1, wherein the recirculation system, the processing chamber, and piping coupling the recirculation system to the processing chamber form a recirculation loop and the fluid supply subassembly comprises means for pressurizing the recirculation loop using the temperature controlled fluid wherein a temperature variation of the temperature controlled fluid during pressurizing is less than approximately ten degrees Celsius.

19. The apparatus of claim 1, wherein the recirculation system, the processing chamber, and piping coupling the recirculation system to the processing chamber form a recirculation loop and the fluid supply subassembly further comprises means for providing a first volume of temperature controlled fluid during a push-through process in which the first volume is larger than the volume of the recirculation loop, wherein the temperature differential within the first volume of temperature controlled fluid during the push-through process is less than approximately ten degrees Celsius.

20. The apparatus of claim 1, wherein the fluid supply subassembly further comprises means for providing a first volume of temperature controlled fluid during a push-through process in which the first volume is larger than the processing chamber volume, wherein the temperature differential within the first volume of temperature controlled fluid during the push-through process is less than approximately ten degrees Celsius.

21. The apparatus of claim 1, wherein the recirculation system, the processing chamber, and piping coupling the recirculation system to the processing chamber form a recirculation loop and the fluid supply subassembly further comprises means for providing a first volume of temperature controlled fluid during a compression cycle in which the first volume is larger than the volume of the recirculation loop, wherein the temperature differential within the first volume of temperature controlled fluid during the compression cycle is less than approximately ten degrees Celsius.

22. The apparatus of claim 1, wherein the fluid supply subassembly further comprises means for providing a first volume of temperature controlled fluid during a compression cycle in which the first volume is larger than the processing chamber volume, wherein the temperature differential within the first volume of temperature controlled fluid during the compression cycle is less than approximately ten degrees Celsius.

23. The apparatus of claim 1, wherein the recirculation system, the processing chamber, and piping coupling the recirculation system to the processing chamber form a recirculation loop and the fluid supply subassembly further comprises means for providing a first volume of temperature controlled fluid during a decompression cycle in which the first volume is larger than the volume of the recirculation loop, wherein the temperature differential within the first volume of temperature controlled fluid during the decompression cycle is less than approximately ten degrees Celsius.

24. The apparatus of claim 1, wherein the fluid supply subassembly further comprises means for providing a first volume of temperature controlled fluid during a decompression cycle in which the first volume is larger than the processing chamber volume, wherein the temperature differential within the first volume of temperature controlled fluid during the decompression cycle is less than approximately ten degrees Celsius.

25. The apparatus of claim 1, wherein the recirculation system, the processing chamber, and piping coupling the recirculation system to the processing chamber form a recirculation loop and the fluid supply subassembly further comprises means for providing a first volume of temperature controlled fluid during a compression cycle and means for providing a second volume of temperature controlled fluid during a decompression cycle, wherein the first volume and the second volume are larger than the volume of the recirculation loop, the temperature differential within the first volume of temperature controlled fluid during the compression cycle being less than approximately ten degrees Celsius, and the temperature differential within the second volume of temperature controlled fluid during the decompression cycle being less than approximately ten degrees Celsius.

26. The apparatus of claim 1, wherein the fluid supply subassembly further comprises means for providing a first volume of temperature controlled fluid during a compression cycle and means for providing a second volume of temperature controlled fluid during a decompression cycle, wherein the first volume and the second volume are larger than the volume of the processing chamber, the temperature differential within the first volume of temperature controlled fluid during the compression cycle being less than approximately ten degrees Celsius, and the temperature differential within the second volume of temperature controlled fluid during the decompression cycle being less than approximately ten degrees Celsius.

27. The apparatus of claim 1, wherein the fluid supply subassembly further comprises a fluid measurement element coupled to the flow-control means for measure the temperature of temperature controlled fluid passing therethrough.

28. The apparatus of claim 1, wherein the fluid supply subassembly further comprises a fluid measurement element coupled to the flow-control means for measure the flow rate of temperature controlled fluid passing therethrough.

29. The apparatus of claim 1, wherein the fluid supply subassembly further comprises a fluid measurement element coupled to the flow-control means for measure the pressure of temperature controlled fluid passing therethrough.

30. The apparatus of claim 1, wherein the recirculation system, the processing chamber, and piping coupling the recirculation system to the processing chamber form a recirculation loop and the fluid supply subassembly further comprises means for providing a first volume of temperature controlled fluid during a system cleaning process in which the first volume is larger than the volume of the recirculation loop, wherein the temperature differential within the first volume of temperature controlled fluid during the decompression cycle is less than approximately ten degrees Celsius.

31. The apparatus of claim 1, wherein the processing chamber comprises a substrate holder that includes means for holding a substrate, and the fluid supply subassembly further comprises means for providing a first volume of temperature controlled fluid during a supercritical substrate cleaning process, wherein the temperature differential within the first volume of temperature controlled fluid during the supercritical substrate cleaning process is less than approximately five degrees Celsius.

32. The apparatus of claim 1, wherein the processing chamber comprises a substrate holder that includes means for holding a substrate, and the fluid supply subassembly further comprises means for providing a first volume of temperature controlled fluid during a supercritical substrate rinsing process, wherein the temperature differential within the first volume of temperature controlled fluid during the supercritical substrate rinsing process is less than approximately five degrees Celsius.

33. The apparatus of claim 1, wherein the processing chamber comprises a substrate holder that includes means for holding a substrate, and the fluid supply subassembly further comprises means for providing a first volume of temperature controlled fluid during a supercritical substrate curing process, wherein the temperature differential within the first volume of temperature controlled fluid during the supercritical substrate curing process is less than approximately five degrees Celsius.

34. The apparatus of claim 1, wherein the processing chamber comprises a substrate holder that includes means for holding a substrate, and the fluid supply subassembly further comprises means for providing a first volume of temperature controlled fluid during a supercritical substrate drying process, wherein the temperature differential within the first volume of temperature controlled fluid during the supercritical substrate drying process is less than approximately five degrees Celsius.

35. A method of operating a fluid supply subassembly comprising:
supplying a first quantity of a fluid at a first temperature to a flow-control means;
supplying a second quantity of a fluid at a second temperature to the flow-control means;
forming a temperature controlled fluid in the flow-control means by controlling a ratio of the first quantity of the fluid to the second quantity of the fluid;
determining a temperature of the temperature controlled fluid;
controlling the ratio of the first quantity of the fluid to the second quantity of the fluid in response to the temperature.

36. A method of operating a processing system comprising a recirculation loop including a processing chamber, a recirculation system, and piping coupling the processing chamber to the recirculation system, the method comprising:
positioning a substrate on a substrate holder in the processing chamber;
sealing the processing chamber;
pressurizing the recirculation loop to a supercritical pressure, wherein a fluid supply subassembly pressurizes the recirculation loop using a first volume of temperature controlled fluid, and wherein a temperature variation of the first volume of temperature controlled fluid during pressurizing is less than approximately ten degrees Celsius;
processing the substrate using a supercritical substrate cleaning process;
performing a push-through process, wherein the fluid supply subassembly provides a second volume of temperature controlled fluid during a push-through process, the second volume being larger than the volume of the recirculation loop, wherein the temperature differential within the second volume of temperature controlled fluid during the push-through process is less than approximately ten degrees Celsius;
performing a pressure cycling process, wherein the fluid supply subassembly provides a third volume of temperature controlled fluid during a first portion of the pressure cycling process and provides a fourth volume of temperature controlled fluid during a second portion of the pressure cycling process, the third volume and the fourth volume being larger than the volume of the recirculation loop, and wherein the temperature differential within the third volume of temperature controlled fluid being less than approximately ten degrees Celsius, and the temperature differential within the fourth volume of temperature controlled fluid being less than approximately ten degrees Celsius;
performing a chamber venting process; and
removing the substrate.

37. The method of operating a processing system as claimed in claim 36 further comprising:
supplying a first quantity of a fluid at a first temperature to the fluid supply subassembly;
supplying a second quantity of a fluid at a second temperature to the fluid supply subassembly;
forming a temperature controlled fluid in the fluid supply subassembly by controlling a ratio of the first quantity of the fluid to the second quantity of the fluid;
flowing the first volume of the temperature controlled fluid from the fluid supply subassembly;
determining a temperature of the temperature controlled fluid in the fluid supply subassembly while pressurizing the recirculation loop;
measuring the temperature of the temperature controlled fluid in the processing chamber while pressurizing the recirculation loop;
determining a temperature difference between the temperature of the temperature controlled fluid in the fluid supply subassembly and the temperature of the temperature controlled fluid in the processing chamber; and
controlling the ratio of the first quantity of the fluid to the second quantity of the fluid in response to the temperature difference.

38. The method of operating a processing system as claimed in claim 37 further comprising keeping the temperature difference less than approximately ten degrees Celsius.

39. The method of operating a processing system as claimed in claim 36 further comprising:
supplying a first quantity of a fluid at a first temperature to the fluid supply subassembly;
supplying a second quantity of a fluid at a second temperature to the fluid supply subassembly;
forming a temperature controlled fluid in the fluid supply subassembly by controlling a ratio of the first quantity of the fluid to the second quantity of the fluid;
flowing the second volume of the temperature controlled fluid from the fluid supply subassembly during the push-through process;
determining a temperature of the temperature controlled fluid in the fluid supply subassembly during the push-through process;
measuring the temperature of the temperature controlled fluid in the processing chamber during the push-through process;
determining a temperature difference between the temperature of the temperature controlled fluid in the fluid supply subassembly and the temperature of the temperature controlled fluid in the processing chamber; and
controlling the ratio of the first quantity of the fluid to the second quantity of the fluid in response to the temperature difference.

40. The method of operating a processing system as claimed in claim 39 further comprising keeping the temperature difference less than approximately ten degrees Celsius.

41. The method of operating a processing system as claimed in claim 36 further comprising:
supplying a first quantity of a fluid at a first temperature to the fluid supply subassembly;
supplying a second quantity of a fluid at a second temperature to the fluid supply subassembly;
forming a temperature controlled fluid in the fluid supply subassembly by controlling a ratio of the first quantity of the fluid to the second quantity of the fluid;
flowing the third volume of the temperature controlled fluid from the fluid supply subassembly during the first portion of the pressure cycling process;
determining a temperature of the temperature controlled fluid in the fluid supply subassembly during the first portion of the pressure cycling process;
measuring the temperature of the temperature controlled fluid in the processing chamber during the first portion of the pressure cycling process;
determining a temperature difference between the temperature of the temperature controlled fluid in the fluid supply subassembly and the temperature of the temperature controlled fluid in the processing chamber; and
controlling the ratio of the first quantity of the fluid to the second quantity of the fluid in response to the temperature difference.

42. The method of operating a processing system as claimed in claim 41 further comprising keeping the temperature difference less than approximately ten degrees Celsius.

43. The method of operating a processing system as claimed in claim 36 further comprising:
supplying a first quantity of a fluid at a first temperature to the fluid supply subassembly;
supplying a second quantity of a fluid at a second temperature to the fluid supply subassembly;
forming a temperature controlled fluid in the fluid supply subassembly by controlling a ratio of the first quantity of the fluid to the second quantity of the fluid;
flowing the fourth volume of the temperature controlled fluid from the fluid supply subassembly during the second portion of the pressure cycling process;
determining a temperature of the temperature controlled fluid in the fluid supply subassembly during the second portion of the pressure cycling process;
measuring the temperature of the temperature controlled fluid in the processing chamber during the second portion of the pressure cycling process;
determining a temperature difference between the temperature of the temperature controlled fluid in the fluid supply subassembly and the temperature of the temperature controlled fluid in the processing chamber; and
controlling the ratio of the first quantity of the fluid to the second quantity of the fluid in response to the temperature difference.

44. The method of operating a processing system as claimed in claim 42 further comprising keeping the temperature difference less than approximately ten degrees Celsius.
